(19) United States
(12) Patent Application Publication
(10) Pub. No.: US 2015/0290924 A1
(43) Pub. Date: Oct. 15, 2015

(54) A METHOD FOR PRECISE ALIGNMENT OF IMPRESSIONS MADE WITH DIFFERENT INKS IN ROTARY PRINTING

(71) Applicant: Walki Group Oy, Pietarsaari (FI)

(72) Inventors: Borje Eriksson, Pietarsaari (FI); Mats Holti, Pietarsaari (FI)

(21) Appl. No.: 14/400,798

(22) PCT Filed: Apr. 26, 2013
(86) PCT No.: PCT/FI2013/050474

§ 371 Date: Nov. 13, 2014

(30) Foreign Application Priority Data
May 15, 2012 (FI) 20125522

(51) Int. Cl. B41F 3/56

(52) U.S. Cl. CPC B41F 3/56

(57) ABSTRACT

In a method for precise alignment of impressions made by different inks, a rotary printing surface is used for printing a material. The different inks to be aligned with respect to each other are printed on different areas of the material by the same rotary printing surface, such as an impression roller.

### FIELD

The aspects of the disclosed embodiments relate to the precise mutual alignment of impressions made with two or more inks, when the rotary printing method is applied. In this context, ink refers to any material to be applied by printing. In particular, the method can be used for manufacturing a laminate that comprises both alignment marks and adhesive patterns.

### BACKGROUND

When conventional graphic printed products are made, the resolution capacity of the human eye is the determining factor that sets the requirements for the precision of the mutual alignment of the colours used for printing. When the use of the printed products is also taken into account, the precision requirements are not very high. Consequently, the rotary printing methods commonly used in industry have been developed to satisfy these precision requirements.

When there is a need to manufacture, by printing, a product for another use than for pleasing the human eye, the precision requirements for the mutual alignment of the colours used in printing may increase substantially. An example of such a product is a laminate in which the laminating adhesive is applied by printing in the form of patterns and where alignment marks are also printed for aligning the further processing of the laminate to the printed adhesive patterns. The precision requirements set by the further processing and the final use on the precision of the mutual alignment of the adhesive patterns and alignment marks are typically clearly higher than in conventional graphic printing, wherein the rotary printing methods commonly used in industry are not sufficient with respect to their precision.

A method is disclosed, based on rotary printing, whereby the mutual alignment precision of inks can be improved in such a way that the precision is sufficient even for the manufacture of the above described laminates and other similar products.

### BRIEF DESCRIPTION OF RELATED DEVELOPMENTS

Various rotary printing methods are commonly used in the printing industry. In a conventional rotary printing machine, a separate printing unit is provided for each colour to be printed; in other words, typically 4 to 8 printing units are provided. The material is passed through the printing machine, and one colour is printed on its surface at a time. In printing machines of the highest precision, all the printing units are driven by servo motors, and the mutual alignment of the printing units is performed by a register control based on computer vision: the register control monitors the alignment of the impressions and controls the servo drives of the printing units in such a way that the alignment remains within an acceptable range. With such an arrangement, it is possible to achieve a precision of ±50 to 100 μm in the mutual alignment of the inks, which is sufficient for graphic printing products.

When it is desired to use a rotary printing press for manufacturing a laminate on which the laminating adhesive is applied in the form of patterns and on which alignment marks are also printed for further processing, two problems are faced with: first of all, the laminating adhesives are often transparent or translucent, wherein it would be difficult for the computer vision of the register control to monitor patterns or marks printed with it; and secondly, the precision of the mutual alignment of the adhesive patterns and alignment marks would not, however, be sufficient to meet the requirements of further processing and the final product. When, for example, a circuit board laminate is made, the further processing and the quality requirements of the final product together require that the adhesive patterns and alignment marks of the laminate be aligned very precisely; the maximum error allowed is typically ±10 to 20 μm, which cannot achieved by normal rotary printing methods.

A solution is disclosed for the way in which even transparent or translucent adhesive patterns and alignment marks can be printed by rotary printing in such a way that the mutual alignment of the adhesive patterns and alignment marks is very precise and sufficient for the manufacture of, for example, a circuit board laminate.

### SUMMARY

The disclosed method is based on the technical solutions of commonly used rotary printing methods, which makes it possible to utilize existing equipment with minor modifications and supplements.

Ink refers to any material to be applied by printing, intended to remain on the material to be printed. Normally, it is a substance that is applied in fluid form and has no specific shape, such as a powdered substance, i.e. “dry substance”, or a liquid substance, but in a special case it may also be a film that can be transferred onto precisely defined areas of a surface. The substrate to be printed may consist of paper, paperboard, plastic film, laminate, or metal foil, such as aluminium, copper, etc.; in general a material that can be passed as a web through a printing unit. The substrate may consist of, for example, a material to be printed “from roll to roll”; in other words, it is unwound from a roll, passed through a printing unit where the different inks are applied onto it, precisely with respect to each other, and re-winded on a roll.

According to an embodiment of the disclosure, inks whose mutual alignment has to be particularly precise, are printed with the same impression cylinder, sleeve or other rotary printing surface. The printing surface can be provided with a pattern by conventional methods, for example by a laser engraving device which is intended for making printing surfaces and which can be used for achieving a very high dimensional precision over the whole printing surface. In the direction of the rotary axis, the printing surface is divided into sections which are used for printing one ink each. Because all the impressions to be precisely aligned are printed by the same high-precision rotary printing surface, there is, first of all, no need for any register control, wherein the possible transparency or translucency of the inks does not have any effect on the precision of the printing, and secondly, very high mutual alignment precision is achieved between the inks printed in this way. For example, when making a circuit board laminate, it is possible to provide patterns corresponding to alignment marks on one or each end of the impression roller and patterns corresponding to adhesive patterns in the middle section, whereby, when printing from roll to roll, a laminate is produced which has alignment marks on one edge or both edges and adhesive patterns precisely aligned with the alignment marks in the middle section, whereby the precision requirements for further processing and the final product are met. The printing surface does not necessarily need to be divided into sections in the direction of the rotation axis in other respects than for the placement of the patterns to be printed with different inks, but if it is advantageous in view of the rotary printing method used, it is possible, for example, to provide grooves or leave elevated rings in the spaces between the areas to be printed with different inks. The groove, ring or the like may be useful, for example, in supplying ink to and/or confining it on each section of the printing surface.

As can already be concluded from what has been said above, the second main embodiment of the disclosure is to supply each section of the printing surface with the respective ink. For example, when making the above described circuit board laminate, one end or both ends of the impression roller are supplied with the ink needed for the alignment marks, and the middle section is supplied with the laminating adhesive. The ink can be supplied to the printing surface in a way typical of the rotary printing method used, but an essential supplement is the fact that the printing unit has to be provided with at least two ink devices in parallel. On one hand, the ink devices may be fully independent and only have a shared printing surface; on the other hand, they may have quite many shared parts as long as the inks are supplied to the device one by one and they cannot be mixed with each other. The choice of the assembly is affected by the rotary printing method used and the printing machine available. For example, in connection with flexography, the inks have to be supplied in separate tanks or chambers, but on the other hand, an anilox roller may be shared or mounted on a common shaft, or it is possible to use separate anilox rollers which face the impression cylinder on different lines. In designing the device, one should therefore aim at a solution for preventing the mixing of the inks, which may influence the choice of which elements to be separate for each ink and which elements to be common for several inks.

### BRIEF DESCRIPTION OF THE DRAWINGS

In the following, we will discuss one advantageous embodiment of the invention by means of the appended drawings.

FIG. 1 shows a side view of an advantageous embodiment of a printing method.

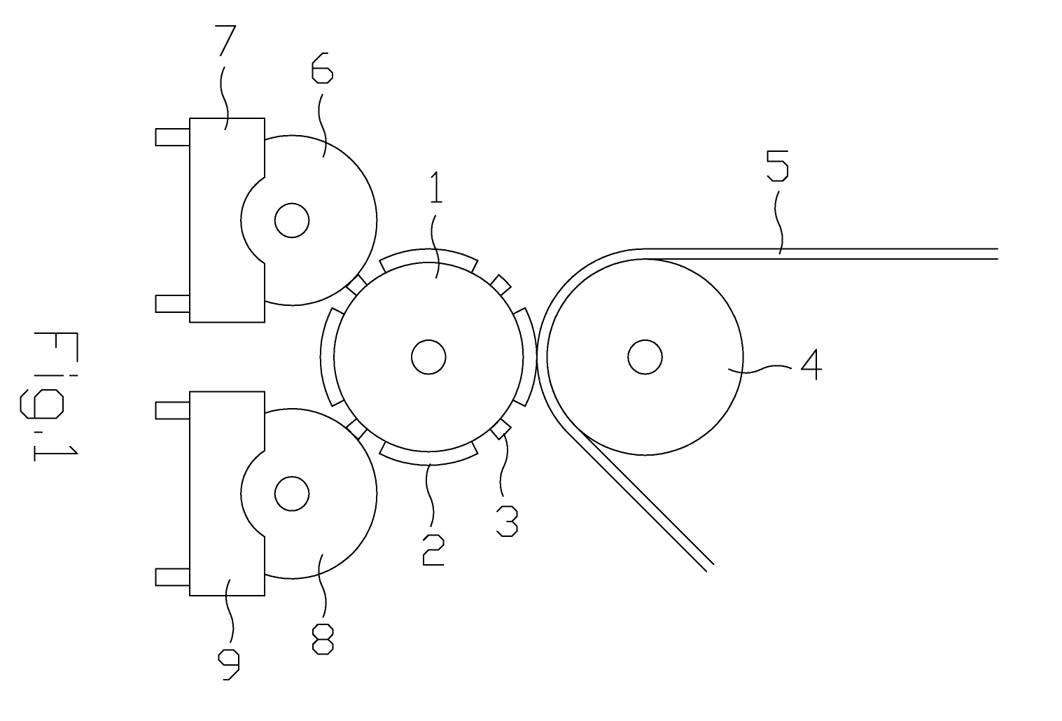

FIG. 2 shows a top view of the same advantageous embodiment of the printing method as is shown by FIG. 1 in a side view.

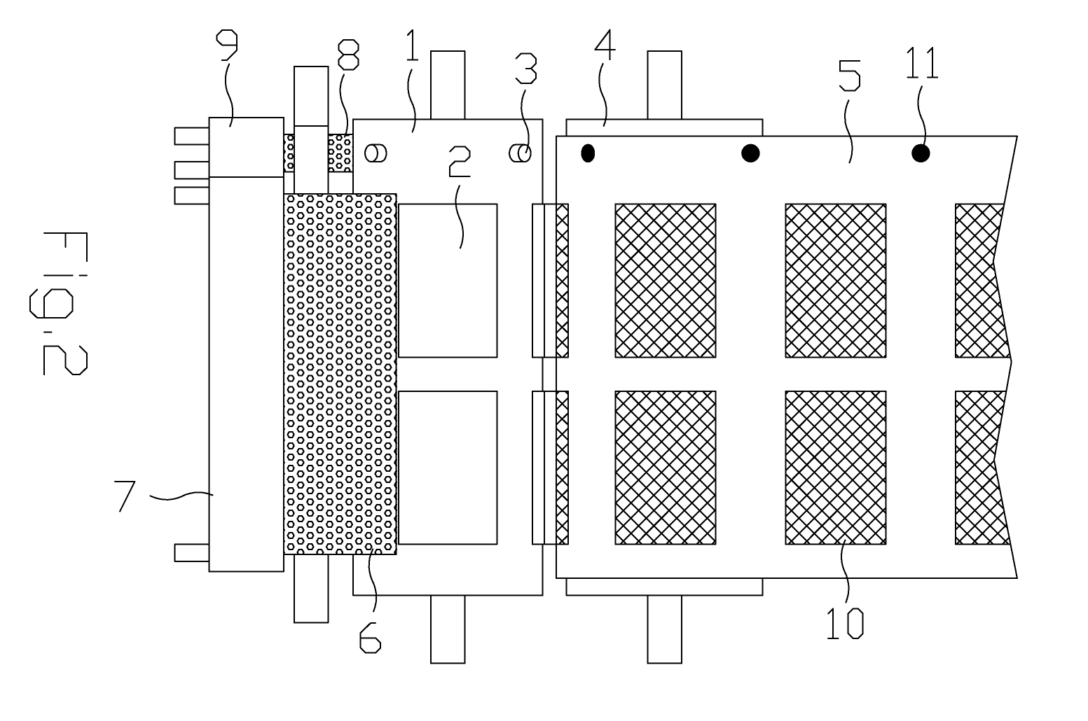

### DETAILED DESCRIPTION OF THE DISCLOSED EMBODIMENTS

The selected advantageous embodiment of the invention is based on flexography.

The figures shows the active components of the printing method; in other words, the frame structures, the bearings and other conventional machine parts are not shown.

An essential part of the embodiment of the invention is an impression roller 1 whose printing surface is divided into sections in such a way that at one end of the roller, embossings 3 are provided for printing alignment marks 11, and in the middle section of the roller, embossings 2 are provided for printing adhesive patterns 10.

The web material 5 to be printed passes through the printing unit in such a way that it runs between the impression roller 1 and a backing roll 4.

So that the two inks to be applied—one being ink for alignment marks and the other being laminating adhesive—can be kept separate, discrete devices are provided for them in this advantageous embodiment: for the laminating adhesive, an anilox roller 6 and a supply chamber 7 against the same, and for the ink of the alignment marks, an anilox roller 8 and a supply chamber 9 against the same.

On the printing surface shown in the drawings, the embossings 3 provided for printing alignment marks and the embossings 2 provided for printing adhesive patterns are placed with respect to each other in such a way that an alignment mark 11 is always printed on the centre line of the empty space between two successive adhesive patterns 10, but quite as well the alignment marks can be placed, for example, on the centre lines of the adhesive patterns or at any desired point between these alternatives. It is essential that the sections (10, 11) containing different inks are precisely aligned on the same material 5 and in the form of separate areas in the direction of the plane of the material.

It is also possible that the different inks are applied from the same rotary printing surface at different stages onto different points (different areas) of the same material 5. For example, the same laminating adhesive can also be applied onto the embossings 3 intended for printing the alignment marks 11, and the actual ink to be applied later, intended for detecting the alignment mark, adheres to these adhesive points, forming the actual final alignment mark 11. The alignment mark to be printed by the impression roller 1 is thus used, in a way, as a “primer”, but the advantage is the same: the alignment can be made by means of sections on the same printing surface, which sections on the printed material correspond to different inks in separate areas in the direction of the plane of the material 5. Similarly, it is possible that the adhesive “primer” printed by the impression roller 1 is used for fixing an alignment mark from the surface layer of a laminate brought into contact with the material 5 to be printed by so-called “cold foil stamping” technique; in other words, the surface layer of such a laminate is intended to be transferred as a uniform film from the laminate onto the adhesive on the surface of the material 5, in the extent of the shape and size determined by this adhesive area, thus forming the areas of ink (detectable alignment marks 11) on the material 5 to be printed. Also, the above mentioned powdered inks, i.e. dry inks, “toners”, are suitable for forming visually detectable alignment marks by applying them on adhesive areas formed by the impression roller.

The invention is not restricted to the embodiment presented in the description above. The advantageous embodiment of the invention shown in the drawings is also easy to utilize in connection with other rotary printing methods based on die-cut embossing, and it can be applied not only to die-cut embossing but to other rotary printing methods as well. The rotary printing surface does not need to transfer the impression directly to the material to be printed, but the impression can also be transferred indirectly; in other words, it will suffice that points which are precisely aligned on this printing surface and intended for printing different inks are finally copied onto the material to be printed. The method can also be applied, for example, in gravure printing methods, offset printing methods, and rotoscreen printing methods. Furthermore, it is obvious that the printing machine used in the printing method may also comprise other printing units than the unit by which the inks to be precisely aligned are printed on the same material. Furthermore, it is obvious that in at least one embodiment of the printing method, the ink devices supply at least two inks onto the printing surface, such as ink for alignment marks and laminating adhesive. Moreover, in one embodiment and in one step of the method, at least two inks are simultaneously provided on the printing surface used.

1. A method for precise alignment of impressions made by different inks in rotary printing, wherein
a rotary printing surface is used for printing a material,
one of said different inks is used for printing alignment marks and the other for printing patterns that will be employed in further processing of the material by means of the alignment marks, and
the patterns are adhesive patterns,
wherein
the different inks or areas corresponding to different inks to be aligned to each other are printed by the same rotary printing surface, such as an impression roller, an impression cylinder, a printing sleeve, or the like, wherein at least two parallel ink devices are provided in the printing unit.

2. The method according to claim 1, wherein the adhesive patterns and the alignment marks are precisely aligned in such a way that the maximum alignment error is ±10 to 20 μm.

3. The method according to claim 1, comprising providing the printing surface with a pattern by a laser engraving device.

4. The method according to claim 1, wherein the further processing is lamination onto the adhesive pattern.

5. The method according to claim 1, wherein the ink with which the adhesive patterns are printed is transparent.

6. The method according to claim 1, wherein the different inks are supplied onto the same rotary printing surface.

7. The method according to claim 1, wherein the same rotary printing surface is divided into at least two sections in the direction of the rotating axis, for printing different inks or areas corresponding to different inks.

8. The method according to claim 8. wherein the same ink is supplied onto two different sections of the same rotary printing surface in the direction of the rotating axis, and the ink on one of the sections is then used for adhering a different ink onto the material.

9. The method according to claim 8, wherein said same ink is an adhesive, and the adhesive supplied on one of the sections is used for forming adhesive patterns on the material, and adhesive supplied onto another, different area is used for forming points for alignment marks on the material, where the ink that forms the actual alignment marks will be adhered later, the ink being a fluid substance or a film to be applied onto the points.

10. The method according to claim 1, wherein the material to be printed is a continuous material web.
